(19) United States
(12) Patent Application Publication
(10) Pub. No.: US 2024/0297033 A1
(43) Pub. Date: Sep. 5, 2024

(54) MASS AND/OR MOBILITY SPECTROMETER VACUUM PUMPING LINE

(71) Applicant: Micromass UK Limited, Wilmslow (GB)

(72) Inventors: Marcus Dawber, Altrincham (GB); Daniel J. Kenny, Knutsford (GB); Joshua Venn, Harrogate (GB); David Gordon, Middlewich (GB)

(73) Assignee: Micromass UK Limited, Wilmslow (GB)

(21) Appl. No.: 18/573,788

(22) PCT Filed: Jun. 23, 2022
(86) PCT No.: PCT/GB2022/051603

§ 371 Date: Dec. 22, 2023

(30) Foreign Application Priority Data
Jun. 23, 2021 (GB) 2108988.3

(51) Int. Cl. H01J 49/24

(52) U.S. Cl. CPC H01J 49/24

(57) ABSTRACT

There is provided a mass and/or mobility spectrometer (200) comprising: a vacuum housing (210) having a first vacuum chamber (212) therein; and a first vacuum pump connected to said first vacuum chamber (212) by a conduit (216); wherein at least a part of the conduit (216) extends along the vacuum housing (210) within a wall of the vacuum housing (210).

### CROSS-REFERENCE TO RELATED APPLICATION

This application claims priority from and the benefit of United Kingdom patent application No. 2108988.3 filed on 23 Jun. 2021. The entire contents of this application are incorporated herein by reference.

### FIELD OF THE INVENTION

The present invention relates generally to mass and/or ion mobility spectrometry and in particular to a mass and/or mobility spectrometer which has an integrated vacuum pumping line for removing gas from one or more sub-atmospheric pressure regions of the spectrometer.

### BACKGROUND

Conventional mass spectrometers typically require vacuum pumping and gas evacuation from various low-pressure regions of the mass spectrometer, such as an ion source region or a vacuum chamber. The apparatus used for vacuum pumping and gas evacuation can be bulky and the manner in which the vacuum pump is connected to the mass spectrometer can cause gas flow instability within the region to be pumped.

It is desired to provide an improved mass and/or mobility spectrometer.

### SUMMARY

The present invention provides a mass and/or mobility spectrometer comprising: a vacuum housing having a first vacuum chamber therein; and a first vacuum pump connected to said first vacuum chamber by a conduit; wherein at least a part of the conduit extends along the vacuum housing within a wall of the vacuum housing.

It is sometimes difficult to configure a spectrometer such that the vacuum pump can be provided in the vicinity of the vacuum chamber that it evacuates. Conventionally, this problem is overcome by using a bellows tube to connect the vacuum pump to the vacuum chamber. However, as such conventional tubing is easily movable, it can cause gas-flow instabilities in the vacuum chamber. Also, such tubing places restrictions on the geometry of the spectrometer and how it can be packaged. In contrast, embodiments of the present invention provide a conduit that is an integral part of the vacuum housing (i.e. formed from the body of the vacuum housing) and that extends from the vacuum chamber along and within the vacuum housing. This arrangement overcomes problems with conventional arrangements.

At least part of the conduit may have an axis therethrough that extends substantially parallel to said wall of the vacuum housing.

The first vacuum chamber may define a longitudinal axis, wherein at least a part of the conduit may have an axis therethrough that extends substantially parallel to the longitudinal axis of the first vacuum chamber.

The conduit within the wall of the housing may extend from an upstream end, that is coincident with a first aperture in a wall of the first vacuum chamber, to a downstream end. Moreover, the conduit may have a bend therein between its upstream and downstream ends.

For example, a first length of the conduit may extend downstream from the first aperture to the bend and a second length of the conduit may then extend downstream from the bend. The first and second lengths of the conduit may be substantially orthogonal to each other, or at an acute or obtuse angle to each other.

The axis through the first aperture (into the upstream end of the conduit) may be substantially orthogonal to said wall of the vacuum housing. Alternatively, the axis through the first aperture may be provided at an angle other than 90 degrees to said wall of the vacuum housing, and the first length of the conduit may extend from the first aperture to the bend along said angled axis.

The spectrometer may be configured to guide ions along a first axis through a second aperture in the first vacuum chamber, which is different to the first aperture into the upstream end of the conduit. The first axis may be substantially orthogonal to the axis through the first aperture (into the upstream end of the conduit).

The first vacuum chamber may comprise an ion-optical element housed therein, such as an ion guide.

The vacuum housing may have a front end at which an ion source is mounted and an opposite, rear end; wherein the conduit extends from a first aperture in a wall of the first vacuum chamber, within the wall of the vacuum housing in a direction extending from said front end to said rear end, and to a downstream end of the conduit that is connected to the vacuum pump.

In these embodiments, the first vacuum chamber may be a source vacuum chamber.

The downstream end of the conduit may be in the rear end of the vacuum housing.

The spectrometer may comprise an ion source; wherein the first vacuum chamber is adjacent the ion source or the ion source is within the first vacuum chamber.

In embodiments wherein the first vacuum chamber is adjacent the ion source, the ion source may be configured to generate ions to be analysed and to introduce said ions to be analysed into the first vacuum chamber.

It is difficult to provide the vacuum pump in the vicinity of such a vacuum chamber and hence a bellows tube has conventionally been used to connect the vacuum pump to such a vacuum chamber. However, as described elsewhere herein, there are problems with such conventional tubing. The conduits according to the embodiments of the present invention overcome such problems.

The conduit may extend at least 2 cm within the wall of the vacuum housing.

For example, the conduit may extend a length within the wall of the vacuum housing that is at least 5 cm, at least 10 cm, at least 15 cm, at least 20 cm, at least 25 cm, at least 30 cm, at least 35 cm, at least 40 cm, at least 45 cm, at least 50 cm, at least 60 cm, at least 70 cm, at least 80 cm, at least 90 cm, or at least 100 cm.

Such configurations ensure that the rigid conduit provided by the body of the vacuum housing extends a relatively long distance downstream from the first vacuum chamber. This helps to minimise gas-flow instabilities when evacuating the first vacuum chamber.

The vacuum housing may house one or more ion-optical elements and/or a mass analyser therein.

The vacuum housing may further comprise one or more vacuum chambers downstream of the first vacuum chamber.

A first downstream vacuum chamber of the one or more vacuum chambers may be immediately adjacent the first vacuum chamber and is configured to receive said analyte ions from the vacuum chamber through the second aperture of the vacuum chamber.

The first downstream vacuum chamber may comprise an aperture and an ion guide arrangement; wherein a second downstream vacuum chamber of the one or more downstream vacuum chambers may be downstream of the first downstream vacuum chamber; and wherein the ion guide arrangement may be configured to transmit said analyte ions from the first downstream vacuum chamber through the aperture to the second downstream vacuum chamber.

The conduit may comprise a cross-section which is one of: (i) circular; (ii) or rectangular or square; (iii) triangular; (iv) V-shaped; (v) elongated oval shaped, and (vi) crescent-shaped. Where the cross-sectional shape is elongated, it is desirably elongated in the horizontal direction such that conduit (and therefore instrument height) may be relatively small.

The conduit may comprise a cross-section which varies along the length of the conduit.

The conduit may comprise one or more turns and/or follows a curvilinear path through the body of the vacuum housing.

The vacuum housing may further comprises a second vacuum chamber configured to receive ions from said first vacuum chamber and a second vacuum pump having an inlet port for evacuating gas from said second vacuum chamber and an outlet port for discharging the evacuated gas, wherein the discharge port is connected in fluid communication with said conduit such that said first vacuum pump pumps gas from the discharge port.

In embodiments where the first vacuum chamber is the source vacuum chamber, the second vacuum chamber may be the first downstream vacuum chamber described herein (i.e. the first vacuum chamber downstream of the source vacuum chamber).

The spectrometer may comprise a port through said wall of the vacuum housing for allowing gas to pass from outside the vacuum housing into the conduit, wherein a tube connects the discharge port of the second vacuum chamber to said port.

The vacuum housing may comprise a plurality of vacuum chambers configured to receive ions from said first vacuum chamber, wherein said second vacuum pump has: a plurality of inlet ports, wherein each inlet port is for evacuating gas from a respective vacuum chamber of said plurality of vacuum chambers; and a single outlet port for discharging the evacuated gas.

The second pump may be a turbomolecular pump.

The first pump may be a roughing pump.

The present invention also provides a method of mass and/or mobility spectrometry, comprising: providing a spectrometer as described herein; and evacuating gas from the first vacuum chamber via said conduit using said first vacuum pump.

The present invention also provides a method of manufacturing a vacuum housing for a mass and/or mobility spectrometer, comprising: forming a vacuum housing having a first vacuum chamber therein; and forming a conduit within and along a wall of the vacuum housing that extends to a first end that opens into the first vacuum chamber.

The method may comprise forming the conduit: by drilling through the vacuum housing; or during casting or three-dimensional printing of the vacuum housing.

The present invention also provides a method of manufacturing a mass and/or ion mobility spectrometer comprising: performing any of the methods described above; and connecting a first vacuum pump to a second end of the conduit that is opposite to the first end.

### BRIEF DESCRIPTION OF THE DRAWINGS

Various embodiments of the invention, together with other arrangements given for illustrative purposes only, will now be described, by way of example only, and with reference to the accompanying drawings in which:

FIG. 1 shows a perspective view of part of a mass spectrometer having a conventional pumping arrangement.

FIG. 2 shows a perspective cross-section view of a part of a mass spectrometer in accordance with an embodiment of the present invention.

FIG. 3 shows a perspective cross-section view of a part of a mass spectrometer in accordance with another embodiment of the present invention.

FIG. 4A shows a perspective view of a part of the mass spectrometer shown in FIG. 3, and FIG. 4B shows a cross-section view of the mass spectrometer shown in FIG. 4A with many of the internal components removed for clarity.

FIG. 5A shows a perspective view of a single integral vacuum housing in accordance with an embodiment. FIG. 5B shows a front view of the single integral vacuum housing of FIG. 5A. FIG. 5C shows a first cross-section view corresponding to the single integral vacuum housing of FIG. 5A. FIG. 5D shows a second cross-section view corresponding to the single integral vacuum housing of FIG. 5A.

### DETAILED DESCRIPTION

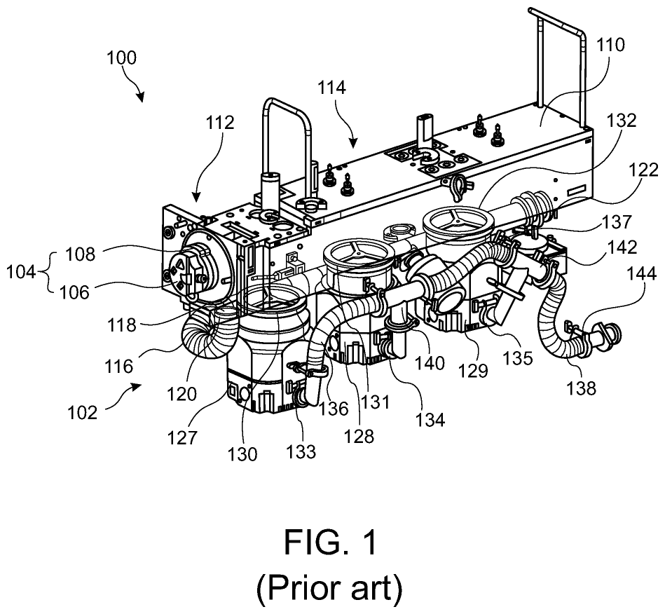

FIG. 1 shows a mass spectrometer 100 having a conventional pumping arrangement 102. The mass spectrometer comprises an ion source 104, which may include an ion block 106 and a pumping block 108, over which a source enclosure (not shown) can be fitted. The mass spectrometer 100 further comprises a vacuum housing 110 for housing a source vacuum chamber 112 and one or more further vacuum chambers 114 pumped by respective turbomolecular pumps 127-129. The conventional vacuum pumping arrangement 102 is provided to form the required vacuum levels within the vacuum chambers 112, 114. In FIG. 1 the main body of the spectrometer is shown faintly, such that the vacuum pumping arrangement 102 that is connected to the underside of the main body can be seen more clearly.

Ions to be analysed are generated in the ion source 104 and then introduced into the source vacuum chamber 112. The ions to be analysed may then be separated within the source vacuum chamber 112 from non-analyte waste material and gasses. For example, the analyte ions may be guided through the source vacuum chamber 112 and into the downstream vacuum chamber 124, whereas most of the gas and waste material may be pumped out of the source vacuum chamber 112 and not transmitted.

As shown in FIG. 1, the vacuum pumping arrangement 102 comprises a roughing line 116 for evacuating the source vacuum chamber 112 to a pressure below the ambient pressure. One end 118 of the roughing line 116 is connected to the source vacuum chamber 112 by fitting 120. Typically, the fitting 120 is a vacuum flange fitting having a pre-set diameter according to manufacturing standards, such as a NW40 welded fitting. The other end 122 of the roughing line 116 is connected to a roughing pump (not shown) to provide the required pumping pressure differential to evacuate the source vacuum chamber 112 through the roughing line 116. The roughing pump may be a rotary vacuum roughing pump, an oil-sealed rotary pump, a scroll pump, or a diaphragm vacuum pump.

As will be appreciated, the vacuum chambers house various ion-optical devices, such as ions guides and mass analysers (not shown). For example, ions to be analysed may be transferred from the ion source 104 to the source vacuum chamber 114, then in a downstream direction through the various vacuum chambers.

The vacuum chambers of vacuum housing 110 will preferentially have progressively higher levels of vacuum (i.e. progressively lower pressures) going from the upstream end to downstream end of the mass spectrometer 100. Turbomolecular pumps are provided to evacuate the vacuum chambers 114 that are downstream of the source vacuum chamber 112. As shown in FIG. 1, three turbomolecular pumps 127-129 are provided. As can also be seen in FIG. 1, the inlets 130-132 of each one of the three turbomolecular pumps, as well as the fitting 120 of the roughing line 116, are connected to the underside of the vacuum housing 110 such that each of the turbomolecular pumps 127-129 and the roughing pump (not shown) withdraw gas from the respective vacuum chamber that it is connected to.

As can be seen in FIG. 1, the outlets of the turbomolecular pumps 127-129 may each comprise a respective fitting 133-135 connected via an arrangement of flexible bellows 136-138 and T-junctions 140 and 142, such that the outlets of the turbomolecular pumps 127-129 are in fluid communication and together exhaust through a downstream end 144 of flexible bellow 138. The fittings 133-135 are conventional vacuum fittings having a pre-set diameter according to manufacturing standards, such as NW 25 welded flange fittings. Similarly, the T-junctions 140, 142 are conventional vacuum fittings.

The inventors have recognised that such a configuration of a conventional pumping arrangement 102 can be problematic. For instance, the roughing line 116 may comprise a NW/KF style corrugated hose or other flexible tubing. Accordingly, this tubing cannot be reliably held in the same position, particularly if the roughing line 116 is detached from the main body of the spectrometer and then reattached. The inventors have discovered that such a conventional pumping arrangement 102 can lead to gas flow instability in the source vacuum chamber 112. For example, without willing to be bound by theory, it is thought that changes in the position of the roughing line 116 relative to the fitting 120 that is attached to the source vacuum chamber 112 may cause instabilities in the source vacuum chamber such as variations in the gas flow being evacuated through pumping line 116. It has been found that this is particularly problematic when such movement of the roughing line 116 occurs at a location close to pumping port of the source vacuum chamber 112. Moreover, the conventional roughing line 116 can be awkward to package in the overall instrument and places limitations on the geometry of the rest of the instrument.

The embodiments of the present invention provide arrangements in which at least an upstream portion of the roughing line is provided by a void within the body of the vacuum housing so as to create a roughing line that is an integral part of the vacuum housing.

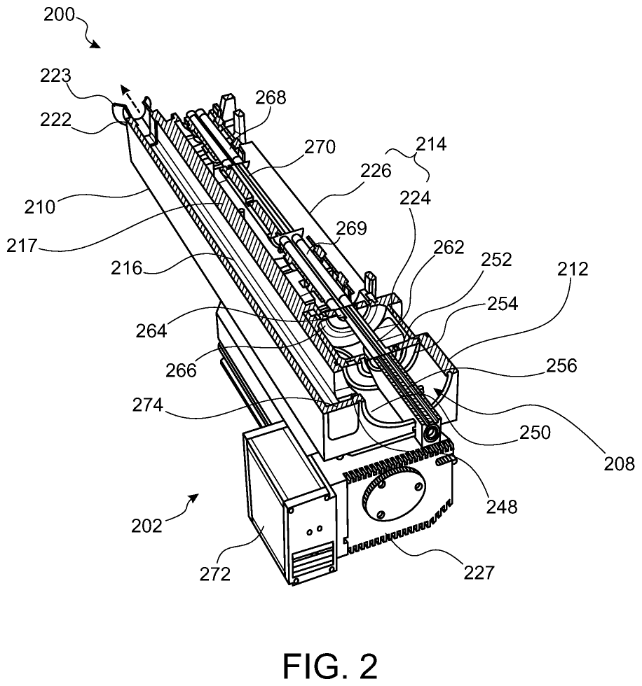

Referring to FIG. 2, some of the principal components of a part of a mass spectrometer 200 having a vacuum pumping arrangement 202 in accordance with an embodiment of the present invention are shown. In particular, FIG. 2 shows a perspective cross-section view of a part of a mass spectrometer 200. The mass spectrometer 200 comprises an ion source (not shown) and a vacuum housing 210. The vacuum housing 210 provides one or more vacuum chambers, such as a source vacuum chamber 212, and one or more further vacuum chambers 214. The one or more further vacuum chambers 214 comprises a first downstream vacuum chamber 224 and may comprise a second downstream vacuum chamber 226. Although only two further vacuum chambers 214 are shown, it will be understood that the vacuum housing can provide one or more additional vacuum chambers downstream of the second vacuum chamber 226.

A first aperture 248 is provided in a first side wall 250 of the source vacuum chamber 212 through which gas from the ion source may be evacuated from the source vacuum chamber 212. A second aperture 252 is provided in a second side wall 254 of the source vacuum chamber 212, through which ions to be analysed are transferred to the first vacuum chamber 224, which is immediately adjacent to and downstream of the source vacuum chamber 212. The source vacuum chamber 212 may include an ion guide 256 to efficiently confine and transfer ions downstream into the one or more further vacuum chambers 214 (through second aperture 252), whilst enabling neutral contamination and gas to be removed from the ion stream.

Still referring to FIG. 2, a roughing line in the form of conduit 216 is provided within the body of the vacuum housing 210. In other words, the roughing conduit 216 may be a void within the body of the vacuum housing, such as a void within a wall 217 of the vacuum housing 210. The conduit 216 may therefore be integral with the body of the vacuum housing 210 that includes the source vacuum chamber 212. The wall 217 of the vacuum housing 210 may be a wall of the one or more further vacuum chambers 214. The conduit 216 may be formed in the vacuum housing 210 by creating a void when the (e.g. metal) vacuum housing 216 is extruded. Alternatively, the conduit 216 may be formed by being drilled through the vacuum housing 210. Alternatively, the conduit 216 may be formed during casting of the vacuum housing 210. In all cases, the conduit 216 is desirably a rigid tube formed by the body of the vacuum housing 210.

The roughing conduit 216 enables gas (and waste material) to be pumped out of the source vacuum chamber 212 so as to reduce the pressure therein to sub-atmospheric pressure. The roughing conduit 216 extends through the body of the vacuum housing 210 to an upstream end at which the first aperture 248 is provided. As will be appreciated, there is no requirement for a vacuum fitting between the roughing conduit 216 and the source vacuum chamber 212, and the roughing conduit 216 is unable to move relative to the source vacuum chamber 212. As such, the gas flow out of the source vacuum chamber 212 remains stable. Also, by forming the roughing conduit 212 within the body of the vacuum housing 210, this removes the complexities encountered when attempting to package conventional roughing tubes (in the form of flexible bellows) within the spectrometer.

The downstream end 222 of the roughing conduit 216 is connected to a roughing pump (not shown) to provide the required pumping pressure differential to evacuate the source vacuum chamber 212. The end 222 of the roughing conduit 216 may be fitted with an interface or fitting 223 to enable connection of the roughing conduit 216 with the conventional vacuum fittings of a conventional roughing pump. The downstream end 222 of the roughing conduit 216 may be configured such that the fitting 223 is a conventional vacuum fitting. The downstream end 222 of the roughing conduit 216 may be connected directly to the roughing pump (not shown) without any further intermediate tubing, or may alternatively be connected to the pump via further tubing. However, even when further tubing is required to connect to the roughing pump, it has been found that the provision of the integral roughing conduit 216 in the vicinity of the source vacuum chamber 212 is sufficient to reduce gas flow instability within the source vacuum chamber 212.

The roughing conduit 216 may extend axially through the vacuum housing 210 such that the downstream end 222 of the roughing conduit 216 discharges at a downstream end of the vacuum housing 210 which may be substantially opposite to the upstream end of the vacuum housing 210 comprising the source vacuum chamber 212. That is, the roughing conduit 216 may extend from the source vacuum chamber 212 through the body of the vacuum housing 210 to the rear of the mass spectrometer. The roughing conduit 216 is shown in FIG. 2 as being linear along most of its length (i.e. having only one bend therein), which may provide a relatively high pumping efficiency of the source vacuum chamber 212. However, it will be understood that the roughing conduit 216 may comprise more than one turn and/or may follow a curvilinear path through the vacuum housing 210.

Still referring to FIG. 2, the one or more further vacuum chambers 214 may house various ion guides and/or other ion-optical elements. For example, analyte ions to be analysed may be transferred through the aperture 252 in the wall 254 of the source vacuum chamber 212 to the first vacuum chamber 224. The first vacuum chamber 224 may include an ion guide 262 that guides the ions to an aperture 264 in a wall 266 of the first vacuum chamber 224. The ions may then pass through this aperture 264 and into the second vacuum chamber 226. The second vacuum chamber 226 may house various ions guides or other ion optical devices for mass and/or mobility analysing the ions. For example, the second vacuum chamber 226 may include one or more of the following: at least one ion guide, a fragmentation or reaction cells for producing fragment or product ions, and a mass analyser.

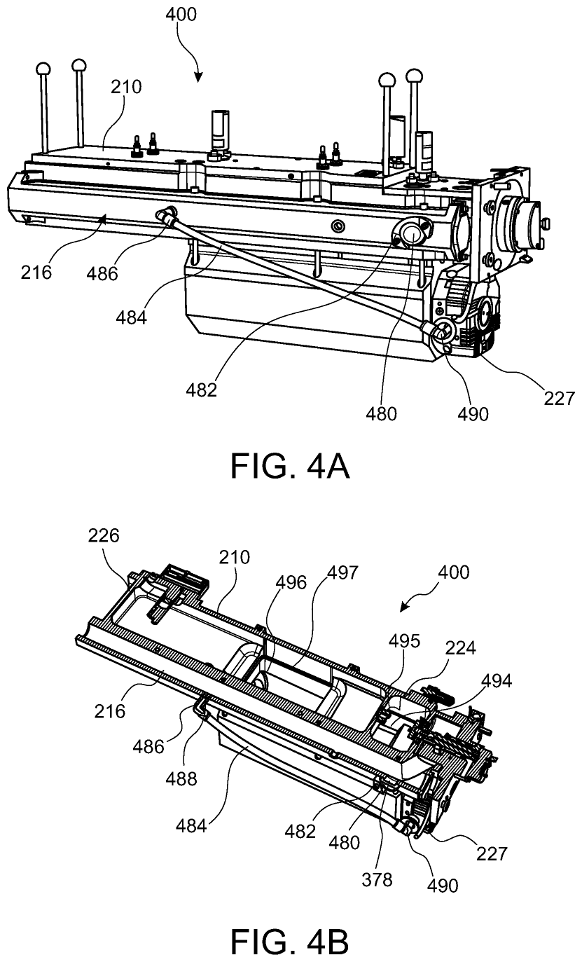

The chambers 212, 214 of vacuum housing 210 in FIG. 2 will preferentially have progressively higher levels of vacuum going from upstream to downstream of the mass spectrometer 200. The mass spectrometer 200 of FIG. 2 comprises a single split-flow turbomolecular pump 227. The turbomolecular pump 227 may be positioned and connected to the underside of the vacuum housing 210. As will be understood, the turbomolecular pump 227 includes an inlet port connected to a port in the first vacuum chamber 224 and an inlet port connected to a port in the second vacuum chamber 226 (as best shown in FIG. 4B) for evacuating the first and second vacuum chambers 224, 226 to the required level of vacuum. The split-flow turbo pump 227 may be controlled by a turbo pump controller 272.

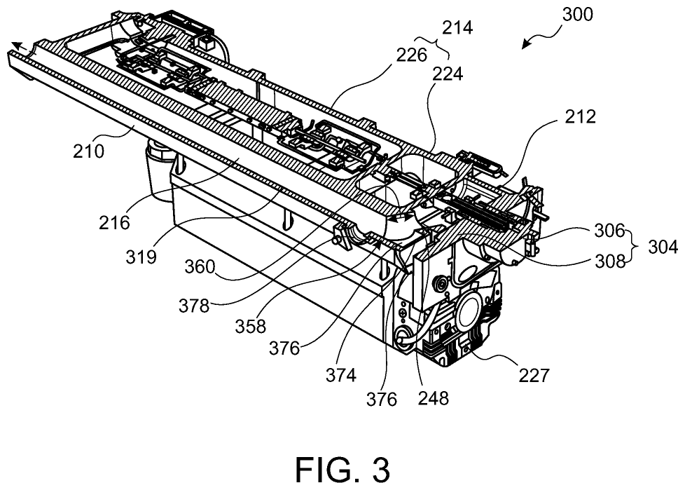

FIG. 3 shows a perspective cross-section view of a part of a mass spectrometer 300 according to an embodiment of the present invention. This embodiment is substantially the same as that shown in FIG. 2, except that the upstream end of the conduit 216 does not include a right-angled bend. Rather, the conduit 216 has a first straight length extending downstream from the aperture 248 to a bend and a second straight length that extends downstream from the bend, where the longitudinal axes of the first and second straight lengths are at an obtuse angle to each other. The ion source 304 is also visible in FIG. 3, which may include source or ion block 306 and a pumping block 308.

FIGS. 4A and 4B show views of the mass spectrometer of FIG. 3, with many of the internal components removed for clarity.

In particular, the mass spectrometer 300 has a roughing conduit 216 with an end region 358, wherein the roughing conduit 216 is open to the aperture 248 of the source region vacuum chamber 212 at the end region 358 of the roughing conduit 216. A passageway 360 extends between the aperture 248 and the end region 358, wherein the passageway 360 is angled with respect to the roughing conduit 216 at an angle other than ninety degrees. This arrangement enables the manufacture of the instrument to be simplified and easier.

The angled passageway 360 may also increase the pumping efficiency of the roughing pump.

The roughing conduit 216 of FIG. 3 is shown with a substantially circular cross-section, as compared to the rectangular or square cross-section of the roughing conduit of FIG. 2. A circular cross-section may also increase the pumping efficiency of the roughing pump as compared to a rectangular or square cross-section. The cross-sectional size and/or shape may vary along the length of the roughing conduit 216, or it may remain constant. It will be understood that the cross-section may be a shape other than circular, or rectangular or square. For example, the cross-section could be triangular, the cross-section could be any polygonal shape such as V-shaped, or non-polygonal shape such as crescent-shaped.

Still referring to FIG. 3, the roughing conduit 216 may also comprise a region 376 which extends in a direction other than toward the roughing pump, such as a closed-end channel 376. The end region 358 or closed-end channel 376 of roughing conduit 216 may have a closed-end 374. The closed-end 374 may be secured to the housing when the mass spectrometer 300 is in use, and may be removable when the mass spectrometer 300 is not in use so as to enable easier cleaning or inspection of the roughing conduit 216. The closed-end 374 may be secured or fastened to the vacuum housing 216 at the end of the roughing conduit 216 by fastening means 376. For example, fastening means 376 may comprise one or more screws or bolts. It will be appreciated that the main part of the roughing conduit 216 may be formed in a simple manner by drilling through the vacuum housing from the front end to the rear end (or vice versa) and then closing the thus formed orifice at the front end by using closure 374. Similarly, the portion of the roughing conduit 216 from the source vacuum chamber to the above-described main part of the roughing conduit may be formed by drilling through the vacuum housing from the outer side of the vacuum chamber to the source vacuum chamber (or vice versa) and then closing the thus formed orifice at the outer side of the vacuum housing by using a cap 480 (shown in FIG. 4).

The roughing conduit 216 may also have a side port 378 provided within an exterior wall of the vacuum housing 210. The side port 378 may be used to insert and seal a pressure sensor within the conduit 216 for monitoring the pressure in the conduit 216. As shown in FIGS. 4A and 4B, the side port 378 may be covered or otherwise blocked via a cap 480 which may be secured to the vacuum housing 210 by a cap fastening means 482.

Referring again to FIGS. 4A and 4B, the turbomolecular pump 227 may be provided with a backing line 484 which fluidically connects the outlet port of the turbomolecular pump 227 with the roughing conduit 216. The backing line 484 may be connected at one of its ends to the roughing conduit 216 by a first backing fitting 486, which connects the backing line 484 to a backing port 488 in an exterior wall of the vacuum housing 210. The other end of the backing line 484 may be connected to the turbomolecular pump 227 via a second backing fitting 490. The backing line 484 may be, for example, a nylon discrete 10 mm diameter backing line.

As described above, the backing line 484 connects the output of the turbomolecular pump 227 to the roughing conduit 216. Therefore, the roughing pump (not shown) is able to pump down the output of the turbomolecular pump 227, via the conduit 216 and backing line 484, to a pressure that is below atmospheric pressure. This reduces the amount of work that the turbomolecular pump 227 is required to do in order to evacuate the vacuum chambers 214 to their respective desired sub-atmospheric pressures.

FIG. 4B shows the inlet ports of the turbomolecular pump 227. A first inlet port 494 of the turbomolecular pump 227 may be arranged to be coincident with an aperture through the wall of the first vacuum chamber 224. Similarly, a second inlet port 497 of the turbomolecular pump 227 may be arranged to be coincident with an aperture through the wall of the second vacuum chamber 226. The turbomolecular pump 227 may comprise one or more further inlet ports to enable pumping of other regions of the vacuum housing 210, such as a third inlet port to pump a further vacuum chamber.

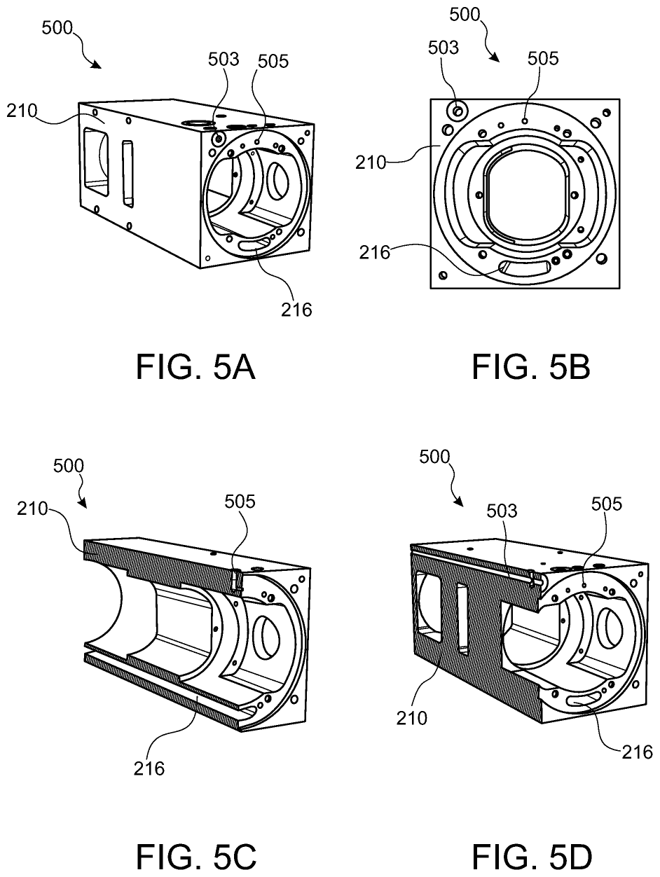

Turning now to FIGS. 5A-5D, various perspective and cross-sectional views of the body of vacuum housing 210 of part of a mass spectrometer 500 are shown. As shown, vacuum housing 210 may comprise other internal conduits or passages. For example, internal conduits 503, 505 may be provided through the body of the vacuum housing so that gases can be delivered through the vacuum housing 210 to the required location, such as to the source vacuum chamber or to the one or more further vacuum chambers. The internal conduits 503, 505 may also be provided so as to enable electronics for powering various components of the mass spectrometer 500 to pass from a power source or controller through the body of the vacuum housing 210 to the various components.

As will be understood, evaporated solvent from the ion source may condense against the internal walls of the source vacuum chamber and drip towards a base of the source region vacuum chamber. Accordingly, an entrance to a waste drainage internal conduit 216 may be adjacent a lowermost internal surface of the source vacuum chamber. In this manner, the solvent waste may drain out of the ion source enclosure by means of gravity. The waste drainage internal conduit 216 may be provided at an angle and extend from the entrance through the vacuum housing to any convenient exhaust port in the housing, such that the solvent flows from the source region vacuum chamber to the exhaust port. The cross-sectional shape of the conduit 216 is an elongated oval extending generally in the horizontal direction. This enables the vacuum housing 210 to be provided with a reduced size in the vertical direction.

As will be understood, the above internal conduits 503, 505 may also extend to and communicate with the one or more further vacuum chambers in a similar manner as described above in relation to the source region vacuum chamber.

As will be understood, one or more of the above described embodiments allows the vacuum housing 210, and therefore the mass spectrometer, to be more compact and have a lower complexity of parts. For example, all of the required conduits such as the roughing conduit, the backing line for the turbomolecular pump, gas feed lines, waste drainage channels, and electronics conduits may be provided as respective extruded within the body of a single integral vacuum housing unit. In some embodiments, the single integral vacuum housing unit may be manufactured via: (i) mould casting, wherein the mould defines the vacuum housing as well as all of the volumes to form the conduits within the vacuum housing; (ii) mould casting, wherein the various conduits are drilled out of the casted block vacuum housing unit; and/or (iii) additive manufacturing or 3D printing.

Although the present invention has been described with reference to preferred embodiments, it will be understood by those skilled in the art that various changes in form and detail may be made without departing from the scope of the invention as set forth in the accompanying claims.

1. A mass and/or mobility spectrometer comprising:
a vacuum housing having a first vacuum chamber therein; and
a first vacuum pump connected to said first vacuum chamber by a conduit;
wherein at least a part of the conduit extends along the vacuum housing within a wall of the vacuum housing.

2. The spectrometer of claim 1, wherein at least part of the conduit has an axis therethrough that extends substantially parallel to said wall of the vacuum housing.

3. The spectrometer of claim 1, wherein the conduit within the wall of the housing extends from an upstream end, that is coincident with a first aperture in a wall of the first vacuum chamber, to a downstream end; and wherein the conduit has a bend therein between its upstream and downstream ends.

4. The spectrometer of claim 1, wherein the vacuum housing has a front end at which an ion source is mounted and an opposite, rear end; and wherein the conduit extends from a first aperture in a wall of the first vacuum chamber, within the wall of the vacuum housing in a direction extending from said front end to said rear end, and to a downstream end of the conduit that is connected to the vacuum pump.

5. The spectrometer of claim 1, comprising an ion source; wherein the first vacuum chamber is adjacent the ion source or the ion source is within the first vacuum chamber.

6. The spectrometer of claim 1, wherein the conduit extends at least 2 cm within the wall of the vacuum housing.

7. The spectrometer of claim 1, wherein the vacuum housing further comprises a second vacuum chamber configured to receive ions from said first vacuum chamber and a second vacuum pump having an inlet port for evacuating gas from said second vacuum chamber and an outlet port for discharging the evacuated gas, wherein the discharge port is connected in fluid communication with said conduit such that said first vacuum pump pumps gas from the discharge port.

8. The spectrometer of claim 7, comprising a port through said wall of the vacuum housing for allowing gas to pass from outside the vacuum housing into the conduit, and wherein a tube connects the discharge port of the second vacuum chamber to said port.

9. The mass spectrometer of claim 7, wherein the vacuum housing further comprises a plurality of vacuum chambers configured to receive ions from said first vacuum chamber, and wherein said second vacuum pump has:
a plurality of inlet ports, wherein each inlet port is for evacuating gas from a respective vacuum chamber of said plurality of vacuum chambers; and
a single outlet port for discharging the evacuated gas.

10. The spectrometer of claim 7, wherein the second pump is a turbomolecular pump.

11. The spectrometer of claim 1, wherein the first pump is a roughing pump.

12. A method of mass and/or mobility spectrometry, comprising:
providing a spectrometer as claimed in claim 1; and
evacuating gas from the first vacuum chamber via said conduit using said first vacuum pump.

13. A method of manufacturing a vacuum housing for a mass and/or mobility spectrometer, comprising:
forming a vacuum housing having a first vacuum chamber therein; and
forming a conduit within and along a wall of the vacuum housing that extends to a first end that opens into the first vacuum chamber.

14. The method of claim 13, comprising forming the conduit:
by drilling through the vacuum housing; or
during casting or three-dimensional printing of the vacuum housing.

15. A method of manufacturing a mass and/or ion mobility spectrometer comprising:
the method of claim 13; and
connecting a first vacuum pump to a second end of the conduit that is opposite to the first end.
